(19) United States
(12) Patent Application Publication
(10) Pub. No.: US 2016/0019558 A1
(43) Pub. Date: Jan. 21, 2016

(54) INTELLIGENT ASSET PLATFORM

(71) Applicant: Shawn Bridy, Radnor, PA (US)

(72) Inventor: Shawn Bridy, Radnor, PA (US)

(21) Appl. No.: 14/732,757

(22) Filed: Jun. 7, 2015

Related U.S. Application Data
(60) Provisional application No. 62/009,249, filed on Jun. 8, 2014.

(51) Int. Cl. G06Q 30/02; G06F 17/30

(52) U.S. Cl. CPC G06Q 30/0201; G06F 17/30867; G06F 17/30598; G06F 17/30958

(57) ABSTRACT

An method of displaying information parameters of an intelligent asset by defining an intelligent asset, gathering information from multiple, channel specific external databases about the intelligent asset, grouping the information according to user-defined information channels, an chronologically displaying the grouped information in a visual timeline over a pre-determined timeframe.

### BACKGROUND OF THE INVENTION

The present invention relates generally to an intelligence system and platform (intelligent asset platform) that actively tracks, highlights and aggregates multiple streams of externally generated information real time based on user pre-selected criteria, which is defined as an intelligent asset, and provides that information in an organized visual dashboard format. The intelligent asset platform is sharable with other stakeholders and provides tools for more effective information monitoring, sharing and collaboration across a variety of information sources and formats.

Product development requires the successful management of the complex interplay of technology, intellectual property, funding, regulatory, commercial, and competitive intelligence. Each of these specialized areas needs to be monitored separately and cooperatively to successfully develop a product. At all stages of development, diverse and current information is required to make appropriate product development decisions. Failure to discover and integrate this diverse information, or communicate it to product development teams in a timely manner can lead to continued development of flawed or unsound products and potentially the early termination of sound ones.

Due to the time and experience required to aggregate and interpret these data, this “intelligence gap” is particularly problematic for early innovators and inventors that may not have the bandwidth and capability to search available data sources online, interpret that information and provide it to their development team in a timely and effective manner.

What is needed therefore is a platform that provides focused and relevant information for product development, that improves the decision making process, minimizes the intelligence gap, and reduces the overall cost of product development.

### SUMMARY OF THE INVENTION

The intelligent asset platform of the present invention actively tracks, highlights and aggregates multiple streams of externally generated information real time based on user pre-selected criteria, and provides that information in an organized visual dashboard format.

The information is categorized by user-defined, information channels and organized so that specialized user groups monitor their specific information channel but also keep abreast of other information channels as well. The intelligent asset platform is sharable with other stakeholders and provides tools for more effective information monitoring, sharing and collaboration across a variety of information sources and formats.

The intelligent asset platform will serve product development teams in the pharmaceutical industry, although it has applicability in other industries which require complex data monitoring across multiple data channels and data sources.

### BRIEF DESCRIPTION OF THE DRAWINGS

The invention is best understood from the following detailed description when read in connection with the accompanying drawings. Included in the drawing are the following figures:

FIG. 1 is a depiction of the current paradigm of data collection as it relates to product development in the pharmaceutical industry;

FIG. 2 is a depiction of the paradigm of data collection as it relates to product development in the pharmaceutical industry using the intelligent asset platform of the present invention;

FIG. 3 is an illustration of a user-friendly dashboard format according to an embodiment of the present invention;

FIG. 4 is an illustration of a portfolio product dashboard format according to an embodiment of the present invention;

FIG. 5 depicts a typical hardware architecture implementation of the present invention.

### DETAILED DESCRIPTION OF THE INVENTION

The intelligent asset platform information provides monitoring and assessment of an intelligent asset, for example, a pharmaceutical drug in development, using a secure and online platform to capture and highlight specific information, defined by the user, across a variety of disparate, multiple databases or data sources. The intelligent asset platform provides real time, simultaneous, asset specific information to stakeholders in a user-friendly dashboard format, allowing the ability to share and comment on information. The intelligent asset platform provides transparency around products and assets by reducing decision time and provides for a better means of distributed collaboration. Information is categorized by user-defined, information channels and organized so that specialized user groups monitor their specific information channel but also keep abreast of other information channels as well.

For pharmaceuticals, an intelligent asset can be a drug, a mechanism of action, a company or any user defined criteria that has information generated about it from multiple external sources.

For pharmaceuticals, multiple channel specific databases include, but are not limited to, openly available databases such as the US and worldwide; patent filings, drug approvals, clinical trials, scientific publications, daily news flow, drug pricing and reimbursement, drug adverse events and recalls, product labels, equity financing and grants. The intelligent asset platform according to the invention is coded to interact with those databases on a daily level through either database download or interacting with online databases.

A user-defined information channel includes categorized work departments commonly found within a specific industry. For example, according to an embodiment of the present invention when the intelligent asset platform is customized to the pharmaceutical industry, user-defined information channels include those job discipline typically found in the pharmaceutical development business. Such disciplines include, for example, regulatory, manufacturing, health economics and outcomes research, pricing and reimbursement, forecasting, intellectual property, and commercial disciplines.

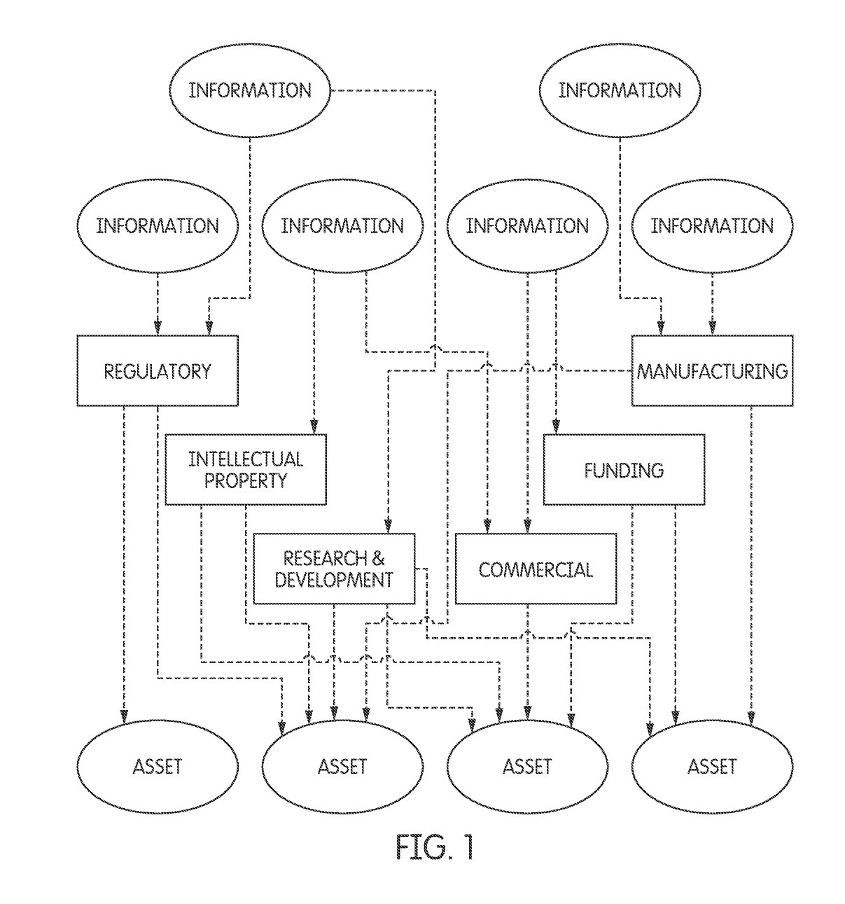

FIG. 1 illustrates the current paradigm of information gather in the pharmaceutical industry. Information is tracked, highlighted and shared by specialty groups around products (assets) in development. Information comes through multiple channels with little consistency, is reliant upon multiple teams to be persistently and proactively tracking all channels of information, and information consolidation for management is hard to achieve without considerable manpower.

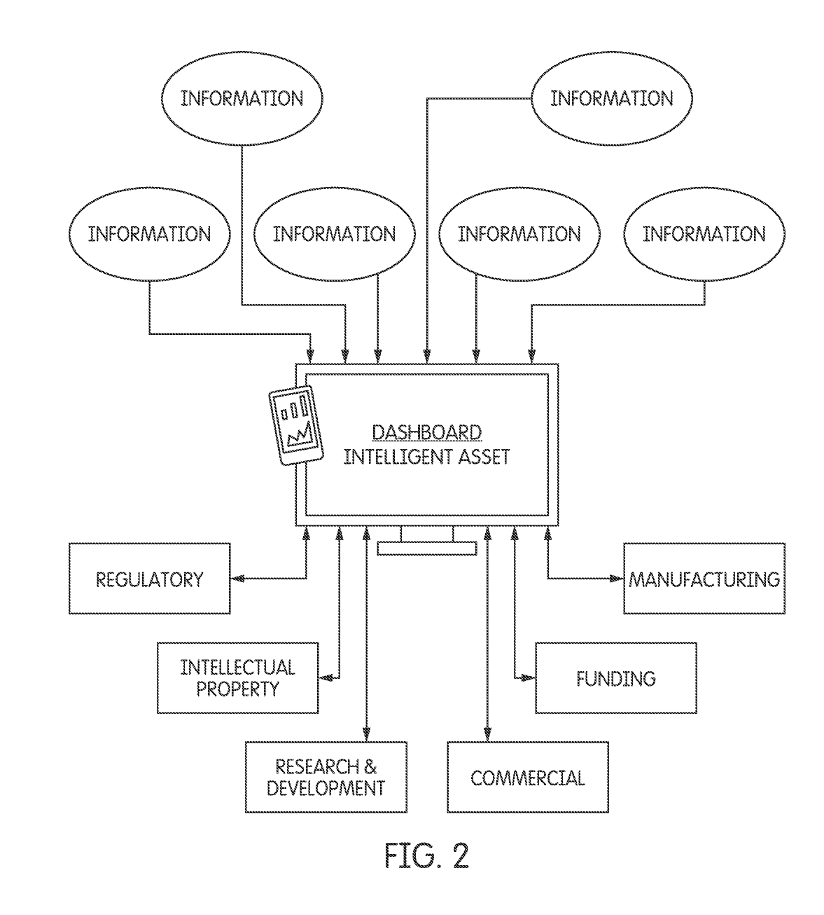

In contrast to current industry practices, FIG. 2 illustrates the paradigm of data collection as it relates to product development in the pharmaceutical industry using the intelligent asset platform of the present invention. External information is actively gathered and filtered and provided to the team simultaneously. After initial set up, the intelligent asset platform of the present invention is not reliant on active participation for external data capture. It provides immediate updates to entire product team and stakeholders simultaneously and information captured is stored for future diligence events or retrospective analysis.

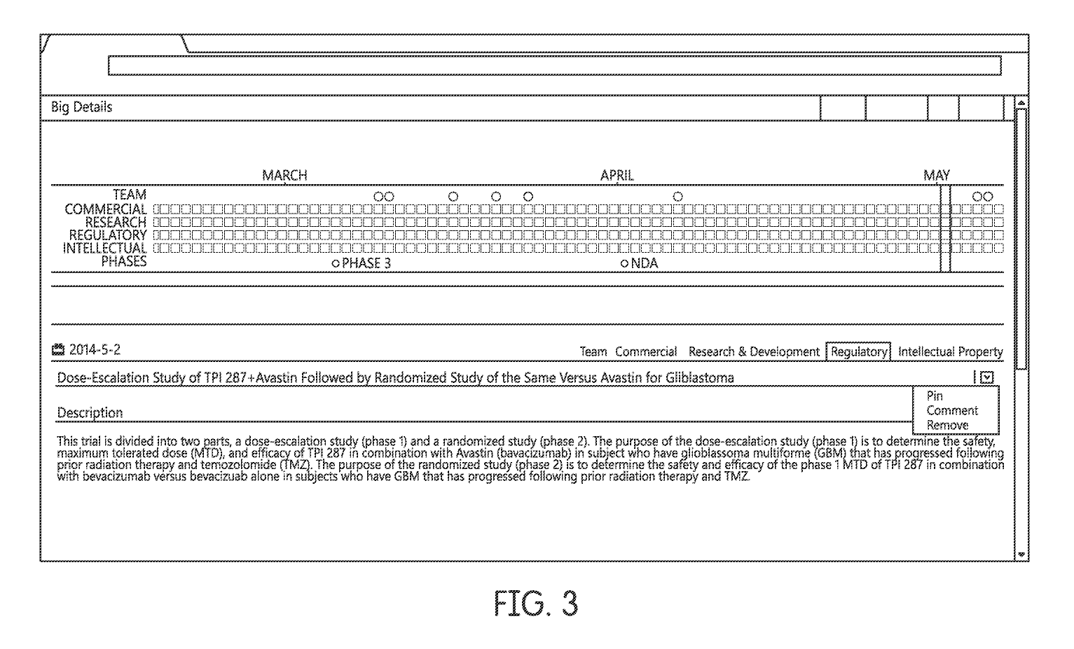

With reference now to FIG. 3, there is shown an exemplary embodiment of a user-friendly dashboard according to an embodiment of the intelligent asset platform of the present invention. In this exemplary embodiment, the intelligent asset is a pharmaceutical drug product, AVASTIN. On a vertical axis, the dashboard displays the following user-defined information channels: team comments, commercial, research, regulatory, intellectual, and product development phases. Time is displayed across the horizontal axis, with a shape, in this example a square block, representing a period of time, such as a day. The total length of time displayed across the timeline is defined by the user beginning when the user defined the intelligent asset and set the intelligent asset platform to gather information. The timeline ranges from, for example, the last 7, 30, 60, 90, 120 or 365 days, or defined by a particular month, quarter (fiscal or monthly) year, or multiples of years.

Each information channel is defined by an individual row. And within each individual row, there are individual icons representing a point in time. A point in time is a day, a week, a month, a quarter, a years or any iteration thereof. In the embodiment shown in FIG. 3, the icon is a square block where each square block in the information channel may be color coded according to the information channel to provide a visual queue. According to the embodiment shown in FIG. 3, each square block is clickable to provide users with information gathered from external databases sorted according to the user-defined information channel. For example, when a user clicks on a colored square in the “Commercial” information channel, a pop-up window or tab appears below the timeline, displays the information that was gathered that day the external databases. A summary of that information is displayed, or a link to the original source of that information is provided for the user. A slider bar allows user to quickly scroll (from left to right similar to a number line) across all events chronologically since initiation of the project.

Also shown in the embodiment of FIG. 3 is a heat map displayed below the timeline. A heat map shows the amount of activity (per day by channel) defined by the number of active data sets the intelligent asset platform gathered from external databases. In addition, the dashboard provides a user-defined information channel defined as a team comment section. This particular information channel allows users to comment and pin (identified by a visual queue, seen in FIG. 3 as a red dot) to the timeline to alert other users that the intelligent asset platform gathered particularly relevant information about the intelligent asset at that particular moment in time.

Another embodiment of the dashboard shown in FIG. 3 is specific to the embodiment where the intelligent asset platform is adapted to the pharmaceutical industry. This user-defined channel, labeled “phases,” denotes the clinical phase of the product in development and its change on the timeline (as shown by black dots).

In yet a further embodiment of the dashboard according to the invention, users upload internally generated files and URL's to share with other users.

According to an exemplary embodiment of the present invention, the intelligent asset platform actively gathers external information, filters the information according to predetermined parameters, and presents the information according to user-defined channels in a user-friendly dashboard format. In an embodiment, after initial set up, the intelligent asset platform collects information in real time, so no additional user participation is necessary for external data capture. Unlimited external data sources can be added to the intelligent asset platform and information channels may be added, altered, or deleted over time as the user sees fit.

In an embodiment, the intelligent asset platform is accessible through a secure, SaaS cloud-based service accessible from a traditional or mobile web browser. All gathered data is stored on a remote server to the user. Alternatively, the intelligent asset platform and data is stored on the users local server or hard drive.

In one embodiment, the information captured by the intelligent asset platform on a particular intelligent asset is stored for future diligence events or retrospective analysis. In the pharmaceutical industry, for example, a company seeking to out-license or divest an asset (such as one of the products in development) can establish the parameters for the intelligent asset platform to capture relevant information about the asset the company would like to divest. The divesting company may offer the acquiring company the ability to follow or track the progress of the company's intelligent asset and use the information gathered by the intelligent asset platform to determine the most desirable time to divest or out-license the asset. Upon completion of a license agreement or an acquisition of the asset, the information captured by the intelligent asset platform may be transferred to the acquiring company.

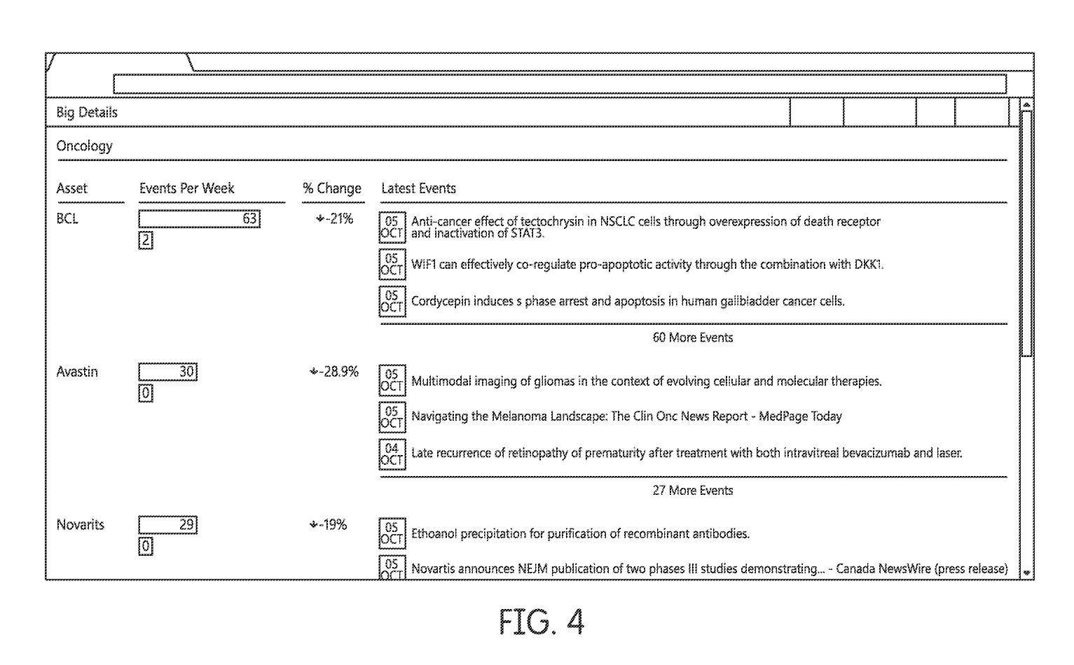

With reference now to FIG. 4, another embodiment of the intelligent asset platform of the present invention is a dashboard illustrating the portfolio product feature of the present invention. The portfolio product dashboard feature aggregates the user-defined intelligent assets in a comprehensive view. In this way, those with oversight of the intelligent assets (such as CEOs, Group Heads, VC's, etc.) are able to monitor activity of all the assets on one comprehensive page. According to this embodiment, each intelligent asset, and the information gathered thereon, are displayed in a stacked view. This allows the status of each intelligent asset in the portfolio product to be quickly assessed and provides a means to rank assets based on activity, allowing for complete transparency from both an external market and internal perspective. Activity is monitored both internally (team contribution) and externally (based on new information aggregated by the site) over a pre-determined time period, such as the last 30, 60, 90 days. The assets are ranked based on activity (defined by external activity as shown in the embodiment of FIG. 4), with the most active intelligent asset being displayed to the top of the page in the most prominent visual position, while the least active intelligent asset is displayed to the bottom of the page. Additionally, pins and phase changes are viewable such as in the case when viewing individual intelligent assets.

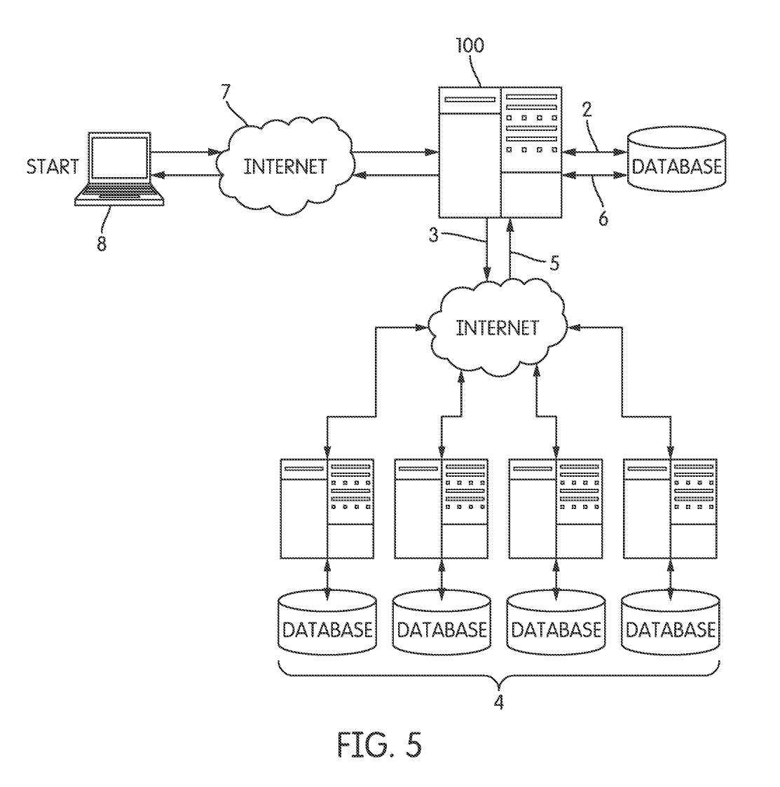

FIG. 5 depicts a typical hardware architecture implementation of the present invention. In this embodiment, the intelligent asset platform utilizes multiple inexpensive computer systems at every level of the architecture. The tasks performed by the processors in each computer system may utilize a variety of underlying software technology such as web servers, application-server and database-server.

A typical embodiment of the present invention will include a data store 120 and a communications link, 2 and 6, between an intellectual asset application server 100, and a look and feel description associated with a dashboard in a secure communications link via the Internet 7 to a user computer 8, and its processor. The intellectual asset application server processor performs the tasks of capturing the look and feel description associated with the dashboard, storing the dashboard on data store 120, searching external databases 4 aligned with the user defined asset, filtering the searched information, assimilating the information for access by the user.

According to an embodiment of the intelligent asset platform of the invention, a user inputs assets and information channels (or alternatively, the information channels may be standardized into a defined set) via webpage or application on a computer or device connected to the Internet 7, which connects through secure connection to the intellectual asset application server 100. The intellectual asset application server 100 qualifies the asset and stores it in data store 120. Once stored, intellectual asset application server 100 processor then performs external database 4 searching through communications over the internet 3, 5, of the asset in accordance with the defined information channels aligned to the industry of the qualified asset. Such external databases 4 may include known publicly available databases or pay-for databases commercially available on the Internet. For example, if the asset is a pharmaceutical product, the databases 4 may include patent filings on the USPTO, drug approvals form the FDA, clinical trials from ClinicalTrials.com, scientific publications from MedScape, daily news flow aggregated by an internet news aggregator, drug pricing and reimbursement from ExpressScripts, and so forth. Information gathered from external databases 4 is assimilatdated along the information channels by intellectual asset application server 100 processor and stored on data store 120.

Intellectual asset application server 100 processor may be programmed to search external databases 4 with high frequency (hourly, daily, etc.) and communicated to a user computer 8, which user computer processor transforms into the dashboard view. Search queries are gathered by intellectual asset application server processor and compared and filtered to previous events gathered by previous searches. Intellectual asset application server 100 processor stores events chronologically and by information channel on data store 120. Such events are provided to user via webpage or application communicated over the Internet to view in chronological display which events are delineated by type of data (channels of information) according to the dashboard format. A user has the ability to: View all events, Sort Events, Broadcast particular events to team (pin), Comment on Events, Remove Events, Search for Historic Events.

What is claimed:

1. An method of displaying information parameters of an intelligent asset comprising the steps of:
defining an intelligent asset;
capturing and filtering information about the defined intelligent asset from multiple, channel specific, external databases via a computer;
grouping said information according to user-defined information channels; and
chronologically displaying said grouped information in a visual timeline; over a pre-determined timeframe.

2. The method of claim 1 wherein the intelligent assets is selected from the group consisting of a company, an approved pharmaceutical product, a drug product in development, a disease, and a therapeutic target.

3. The method of claim 1 wherein the multiple, channel specific external databases are selected from the group consisting of the US and worldwide patent filings, FDA drug approvals, US and worldwide clinical trials, scientific publications, daily news flow, drug pricing and reimbursement, drug adverse events and recalls, product labels, equity financing and grants.

4. The method of claim 1 wherein the user-defined information channels are selected from the group consisting of regulatory, health economics and outcomes research, pricing and reimbursement, forecasting, intellectual property, and commercial.

5. The method of claim 1, wherein the chronological display has an x-axis displaying the user-defined information channels, and on a y-axis, time having units of a day.
